(19) United States
(12) Patent Application Publication
(10) Pub. No.: US 2009/0246448 A1
(43) Pub. Date: Oct. 1, 2009

(54) THERMOPLASTIC POLYMER/COLORANT TOW AND FLOCKED ARTICLES PREPARED THEREFROM

(76) Inventors: Francoise Henrio, Monteleger (FR); Veronique Bossennec, Serezin-du-Rhone (FR); Cecile Lopez, Saint Marcel Bel Accueil (FR)

Correspondence Address: BUCHANAN, INGERSOLL & ROONEY PC, POST OFFICE BOX 1404, ALEXANDRIA, VA, 22313-1404, US

(21) Appl. No.: 12/279,386

(22) PCT Filed: Feb. 9, 2007
(86) PCT No.: PCT/EP2007/051280

§ 371 Date: Jan. 9, 2009

(30) Foreign Application Priority Data
Feb. 14, 2006 (FR) 0601279

(51) Int. Cl. D04H 11/00; C08K 3/22; C08K 5/3417

(52) U.S. Cl. 428/90; 524/430; 524/105

(57) ABSTRACT

A continuous filament thermoplastic polymer/colorant tow, the filaments of which are formed from a composition containing at least one matrix including a thermoplastic polymer and a colorant, and, optionally, at least one light and/or heat stabilizer, and is converted into useful flocked articles, e.g., vehicle interiors, having such properties as good light and/or heat fastness.

The invention relates to a thermoplastic polymer tow for a flocked article, the filaments of which are obtained by spinning a composition comprising at least one matrix based on a thermoplastic polymer and one colorant, preferably also one light and/or heat stabilizer. The invention also relates to a flocked article, the fibres of which are obtained by spinning this composition. The invention relates more particularly to a coloured tow and a coloured flocked article having good light and/or heat fastness properties.

Flocked articles may be used, in particular, as textiles articles in the clothing, furnishings or automotive industries. They have various appearances and properties, which are a function of their field of application.

In the automotive field for example, the flocked articles may be used as decorative parts, for example as seat covers, door panels, cabinets, courtesy lights, parcel shelves, convenience compartments, etc. They may also be used as functional parts, for example as acoustic parts under the bonnet, window guides, etc.

Furthermore, polyamides are synthetic polymers widely used for manufacturing yarns, fibres and filaments. These fibres, yarns and filaments are then used for producing textile surfaces, and in particular dyed textile surfaces.

Polyamides may be degraded when they are subjected to the elements or to external conditions such as UV rays, heat and adverse weather. Degradation may also be caused by the heat used during their manufacture and/or shaping. This instability is especially expressed by degradation, loss of mechanical properties and colour changes. These problems may become critical for a certain number of applications, especially in the automotive field.

In addition, the flocked articles are generally coloured, the dyeing step generally being carried out after spinning. It may especially be carried out continuously on the tow, on the chopped fibres before flocking, or on the flocked articles. These flocked articles, for which the dyeing is carried out after spinning—for example by dipping the fibres in a dye bath—have inadequate light and heat fastness properties. It is especially desired to prevent a change from the original colour of the flocked articles when they are subjected to the elements or to external conditions such as UV rays, heat and adverse weather. In the automotive field especially, standards have been developed that require high levels of light fastness.

In this regard, the invention provides, in a first subject, a tow for a flocked article that does not have these drawbacks. It is a thermoplastic polymer tow formed from a plurality of continuous filaments, the filaments being obtained by spinning a composition comprising at least one matrix based on a thermoplastic polymer and one colorant, preferably also one light and/or heat stabilizer.

In a second subject, the invention relates to the use of this tow for preparing flocked articles.

The invention also relates, in a third subject, to a flocked article comprising the fibres obtained by spinning a composition comprising at least one matrix based on a thermoplastic polymer and one colorant, the composition being as described above. Finally, the invention relates, in a fourth subject, to the use of a flocked article, as a vehicle interior lining or as a vehicle interior article.

Thus the invention relates, in a first subject, to a tow for a flocked article that does not have these drawbacks. It is a thermoplastic polymer tow formed from a plurality of continuous filaments, the filaments being obtained by spinning a composition comprising at least one matrix based on a thermoplastic polymer and one colorant, preferably also one light and/or heat stabilizer.

Tows for flocked articles are known to a person skilled in the art. They are a large bundles of continuous filaments manufactured without twisting, assembled in a form similar to a loose rope and held together. A tow is generally obtained by melt-spinning filaments, then gathering and drawing these filaments. The tow generally has a linear density between 4 and 800 ktex. This tow is generally chopped into short fibres using a cutting technique known to a person skilled in the art, for example using a guillotine or a knife wheel. The methods for obtaining these tows are known to a person skilled in the art.

The composition according to the invention comprises at least one matrix based on a thermoplastic polymer and one colorant, preferably also one light and/or heat stabilizer.

The thermoplastic polymer of the matrix may, for example, be chosen from a polyamide, in particular nylon-6 or nylon-6,6 or blends or copolymers thereof; a polyester (such as polyethylene terephthalate or polybutylene terephthalate); an acrylic; a polyolefin (such as polypropylene), viscose; or rayon.

The term “colorant” is understood to mean a compound providing colour to a substrate. It could be organic or inorganic pigments, dyes or mixtures or combinations thereof. Advantageously, the colour of the colorant is other than white. Preferably, the colour of the tow of the invention is other than black.

When the pigment or dye is inorganic, it is advantageously a metal oxide such as iron oxide. When the inorganic pigment or dye is a metal compound, the metal is preferably other than cadmium. As examples of cadmium compounds, mention may be made of cadmium sulphide (CdS) and cadmium selenide (CdSe). Even more preferentially, the metal of the inorganic pigment or dye is other than lead, cadmium and chromium (VI). This is because these metals are heavy metals that are highly toxic.

When the pigment or dye is organic, it is advantageously a pigment or dye chosen from perylenes, phthalocyanine derivatives, such as copper phthalocyanine, indanthrone, benzimidazolone, quinacridone, perinone and azomethine derivatives. Preferably, the organic pigment or dye is chosen from perylenes, phthalocyanine derivatives and azomethine derivatives. According to one particular embodiment of the invention, these pigments or dyes are not water soluble.

The colorant is added to the thermoplastic polymer matrix according to any method known to a person skilled in the art. It may, for example, be added to the molten polymer in a mixing device such as an extruder, directly or else by means of a masterbatch.

The composition according to the invention advantageously comprises between 0.005 and 5%, preferably between 0.01 and 3% by weight of colorant relative to the weight of the composition.

Preferably, the composition according to the invention comprises at least one light and/or heat stabilizer.

These stabilizers are known to a person skilled in the art and are often classified according to their mode of action: conventional antioxidants, redox antioxidants, organic or mineral UV stabilizers, light stabilizers, UV absorbers, metal deactivators, hydroperoxide reducing agents and coordination compounds.

As examples of stabilizers, mention may be made of light stabilizers having at least one hindered amine unit (hindered amine light stabilizer or HALS). Such additives are, for example, described in patent applications WO 2004/000921 and WO 2005/040262. These stabilizers may be introduced during the polymerization of the thermoplastic polymer-based matrix, or they may be blended with the matrix according to any method known to a person skilled in the art. Advantageously, the composition comprises between 0.1 and 0.5%, preferably between 0.15 and 0.5% by weight of this type of stabilizer relative to the weight of the composition.

As another type of stabilizer that is suitable within the scope of the invention, mention may be made of hindered phenolic antioxidants. Such antioxidants are, for example, described in patent applications WO 2004/000921 and WO 02/053633. Advantageously, the composition comprises between 0.1 and 0.3% by weight of this type of stabilizer relative to the weight of the composition.

Other suitable stabilizers are phosphorus-based stabilizers, such as phosphites substituted by alkyl and/or aryl radicals, for example tris-(2,4-di-tert-butylphenyl) phosphite; phosphorous acid, hypophosphorous acid, etc. Advantageously, the composition comprises between 0.01 and 0.04% by weight of this type of stabilizer relative to the weight of the composition.

Mention may also be made of the UV absorbers that are especially described in patent application WO 2004/000921.

Inorganic or organic salts, such as copper compounds, are also suitable. They are generally used in combination with alkali metal halide salts. A stabilizer of this type is advantageously introduced into the matrix at a level of 5 to 500 ppm (mg per kilo of polymer), said concentration being expressed as elemental copper.

Manganese compounds may also be mentioned as stabilizers. These manganese compounds may be a manganese salt, for example obtained from a mineral and/or organic acid.

The manganese salts are preferentially chosen from the group comprising: manganese oxalate, manganese lactate, manganese benzoate, manganese stearate, manganese acetate, manganese hypophosphite, manganese silicate, manganese pyrophosphate and manganese chloride.

A stabilizer of this type is advantageously introduced into the matrix at a level of 5 to 500 ppm (mg per kilo of polymer), said concentration being expressed as elemental manganese.

Advantageously, the stabilizer is chosen from hindered phenolic antioxidants, phosphorus-based stabilizers, copper compounds and manganese compounds.

The stabilizer is added to the thermoplastic polymer matrix according to any method known to a person skilled in the art. It may, for example, be introduced during the polymerization of the thermoplastic polymer matrix. It may also be added to the molten polymer in a mixing device such as an extruder, directly or else by means of a masterbatch.

The composition according to the invention may comprise, where appropriate, a large variety of additives such as delustrants, mattifying agents, for example titanium dioxide and/or zinc sulphide particles, agents for modifying properties, such as the antistatic behaviour, the hydrophilicity, the antistaining or antisoiling effect, the flame retardancy and the bioactivity, and (organic or mineral) fillers, alone or as a blend.

The filaments of the tow according to the invention may have a linear density between 0.1 and 100 dtex The filaments advantageously have a linear density between 0.5 and 60 dtex, preferably between 0.5 and 22 dtex, more preferentially between 0.5 and 7 dtex, even more preferentially between 0.5 and 4 dtex.

The filaments may have various cross-sectional shapes, such as round or multilobed shapes. They may also be hollow filaments.

The invention also relates, in a second subject, to the use of the tow described above for preparing a flocked article. As indicated above, the tow is chopped into short fibres using a cutting technique known to a person skilled in the art, for example using a guillotine or knife wheel. Then a flocked article is prepared from these fibres. The flocked articles obtained have very good light and/or heat fastness properties.

The invention also relates, in a third subject, to a flocked article comprising fibres obtained by spinning a composition comprising at least one thermoplastic polymer-based matrix and one colorant, the composition being as defined above. Advantageously, the flocked article comprises at least 50%, preferably at least 80% by weight relative to the weight of the fibres, fibres such as defined above.

Everything which has been described above relating to the composition of the tow filaments and relating to the tow filaments respectively, applies in the same way here to the composition of the flocked article fibres and to the flocked article fibres respectively.

The flocked articles of the invention may be two-dimensional flocked surfaces, which may be used as coverings for two- or three-dimensional articles, such as seats, courtesy lights, etc.

The flocked articles may also be three-dimensional articles, such as courtesy lights, cabinets, convenience compartments, parcel shelves, boots, adjustment seals, window guides, etc, They are generally produced by direct flocking of the three-dimensional article.

Methods for manufacturing flocked articles are known per se. Briefly, and without this constituting any limitation to the scope of the invention, they generally consist in coating a substrate with an adhesive and spraying very short fibres. Thus the fibres adhere to the substrate, preferably in an approximately perpendicular direction.

The fibre spraying may be carried out by vibrating the support or by an electrostatic means, or by a combination of these two techniques. Within the context of electrostatic spraying, the fibre is generally electrically activated so as to be oriented and sprayed in the electrostatic field. The fibre may be activated by an activation treatment. As examples, two large families of activation treatments may be mentioned: treatments based on tannins and those based on colloidal silica.

The substrate may be a two- or three-dimensional surface.

The adhesives that may be used to bond the flocked fibres, their methods of application to the substrate, and the substrate are known to a person skilled in the art and do not constitute a limitation to the invention. Depending on the type of substrate, a treatment prior to the application of the adhesive may be necessary. As examples of prior treatment, mention may be made of: plasma treatment, corona treatment, flame treatment, coating with a primer, etc.

During the step of flocking the fibres according to the invention, the latter are mixed, which contributes to the final homogeneous appearance of the flocked surface.

The fibres of the flocked article of the invention may have a length between 0.1 and 6 mm. Fibres having a length between 0.3 and 4 mm are preferred.

The fibres may be flat or crimped. They may have a two-dimensional crimp and/or a three-dimensional crimp. The two-dimensional crimp of the fibres is generally obtained by mechanical crimping.

It is also possible to use a mixture of different fibres, materials, linear densities, lengths and textures.

The flocked article of the invention may be subjected to finishing operations. Such operations are known to a person skilled in the art. They may be, for example, applying a size or a chemical agent (for example by padding) to the article, so as to give it antistaining or antisoiling properties, impermeability, antistatic behaviour, bioactivity, flame retardancy, etc. The article may also be subjected to a calendering operation so as to give it special effects.

The flocked articles of the invention have good light and/or heat fastness properties. They can therefore be used in the field of vehicle interior linings, which are particularly vulnerable to light and/or heat.

Thus the fourth subject of the invention relates to the use of the flocked article described above as a vehicle interior lining when it is a flocked surface, or as a vehicle interior article when it is a three-dimensional article.

The term “vehicle” is understood to mean any means of transport by land, air or sea. As examples of vehicles, mention may be made of tourism vehicles, cars, trains, utility vehicles, all-terrain vehicles, two-wheeled vehicles, heavy goods vehicles, public transport vehicles (bus, metro, etc.), aeroplanes, boats, etc.

Advantageously, the vehicle is a car. As examples of car interior linings or car interior articles that are suitable within the scope of the invention, mention may be made of seat coverings, door panels, cabinetwork, cabinets, courtesy lights, parcel shelves, convenience compartments or any other decorative parts.

Other details or advantages of the invention will become more clearly apparent in the light of the examples given below, solely by way of indication.

### EXAMPLES

### Preparation of the Tows and the Fibres

### Example 1C (Comparative)

The manufacture of a nylon-6,6 was carried out by adding, into a polymerization reactor, 92.56 kg of dry nylon salt (hexamethylene diammonium adipate salt) in 86.71 kg of water, 1380 g of caprolactam, 137 g of 32.3 wt % hexamethylene diamine in water and 6.5 g of antifoaming agent.

The polyamide was manufactured according to a standard nylon-6,6 polymerization method

6.1 kg of a 20 wt % titanium dioxide suspension were added during the pressure distillation phase.

The polymer obtained was cast in the shape of rods, cooled and formed into granules by cutting the rods.

The viscosity index of the polymer obtained, determined from the granules, was 132 ml/g (according to the ISO EN 307 standard).

The amine end groups were measured to be 51.6 meq/kg by potentiometer.

The dried nylon-6,6 was extruded and spun at 4200 m/min using a spinneret with 20 holes and an extrusion temperature of 285° C. The filaments obtained had a linear density of 1.9 dtex per strand, and a round cross section.

The tow was then chopped into fibres with a length of 0.9 mm.

The fibres obtained were then dyed and treated.

The fibres were dyed conventionally using a method known to a person skilled in the art.

The fibres were dispersed in water. The dyeing was carried out in a bath with a dilution of 1/30 by weight.

The fibres were dyed in an open bath using the mixture of the following colorants: 0.0079% of IRGALANE® Bordeaux EL200%, 0.0235% of IRGALANE® Yellow 3RL KWL250% and 0.0913% of IRGALANE®) Grey GLN (the percentages being expressed by weight relative to the weight of the fibres). The colorants chosen were recommended and used for meeting the specifications of the automotive market (UV and temperature resistance). The colour obtained was grey.

Added to the dye bath were: 1% of a levelling agent, then 2.2% by weight, relative to the weight of the fibres, of a product sold by Ciba under the reference CIBAFAST® N2

The fibres were then rinsed and dried.

The fibres were then subjected to an activation treatment based on tannin and aluminium sulphate.

### Example 1

The manufacture of a nylon-6,6 was carried out by adding, into a polymerization reactor, 92.56 kg of dry nylon salt (hexamethylene diammonium adipate salt) in 86.71 kg of water, 1380 g of caprolactam, 137 g of 32.3 wt % hexamethylene diamine in water, a phosphorus-based acid catalyst compound of the phosphoric acid type, an oligomeric HALS type compound and 6.4 g of antifoaming agent.

The final phosphorus concentration in the polymer was around 50 ppm of P. The final concentration of HALS-type compound was 0.21 % by weight relative to the weight of the polymer.

The polyamide was manufactured according to a standard nylon-6,6 polymerization method.

6.1 kg of a 20 wt % titanium dioxide suspension were added during the pressure distillation phase.

The polymer obtained was cast in the shape of rods, cooled and formed into granules by cutting the rods.

The viscosity index of the polymer obtained, determined from the granules, was 128 ml/g (according to the ISO EN 307 standard).

The amine end groups were measured to be 56.5 meq/kg by potentiometer.

A black pigment and a copper salt were introduced in the form of a masterbatch in nylon-6.

1% by weight of the masterbatch was introduced into the PA-6,6 in an extruder at an extrusion temperature of 285° C. The blend was then melt-spun at 4200 m/min using a spinneret with 20 holes. The filaments obtained had a linear density of 1.9 dtex per strand, and a round cross section. The colour obtained was grey.

The tow was then chopped into fibres with a length of 0.9 mm.

The fibres were then subjected to an activation treatment based on tannin and aluminium sulphate. 2.2% by weight, relative to the weight of the fibres, of a product sold by Ciba under the reference CIBAFAST®) N2 were introduced during treatment of the fibres.

### Example 2C (Comparative)

The manufacture of a nylon-6,6 was carried out by adding, into a polymerization reactor, 92.56 kg of dry nylon salt (hexamethylene diammonium adipate salt) in 86.71 kg of water, 1380 g of caprolactam, 137 g of 32.3 wt % hexamethylene diamine in water, 9 g of manganese salt tetrahydrate and 6.5 g of antifoaming agent.

The polyamide was manufactured according to a standard nylon-6,6 polymerization method.

6.06 kg of a 20 wt % titanium dioxide suspension were added during the pressure distillation phase.

The polymer obtained was cast in the shape of rods, cooled and formed into granules by cutting the rods.

The viscosity index of the polymer obtained, determined from the granules, was 129 ml/g (according to the ISO EN 307 standard).

The amine end groups were measured to be 55 meq/kg by potentiometer.

The dried nylon-6,6 was extruded and spun at 4200 m/min using a spinneret with 20 holes and an extrusion temperature of 285° C. The filaments obtained had a linear density of 1.9 dtex per strand, and a round cross section.

The tow was then chopped into fibres with a length of 0.9 mm.

The fibres obtained were then dyed and treated.

The fibres were dyed conventionally using a method known to a person skilled in the art.

The fibres were dispersed in water. The dyeing was carried out in a bath with a dilution of 1/30 by weight.

The fibres were dyed in an open bath using a mixture of the following colorants: 0.053% of LANASYN® Yellow S2GL sold by Clariant, and 0.016% of LANASYN® Dark Brown SGL sold by Clariant (the percentages being expressed by weight relative to the weight of the fibres). The colorants chosen were metalliferous colorants recommended and used for meeting the specifications of the automotive market (UV and temperature resistance). The colour obtained was beige.

Added to the dye bath were: 1% of a levelling agent, then 2.2% by weight, relative to the weight of the fibres, of a product sold by Ciba under the reference CIBAFAST® N2

The fibres were then rinsed and dried.

The fibres were then subjected to an activation treatment based on tannin and aluminium sulphate.

### Example 2

The manufacture of a nylon-6,6 was carried out by adding, into a polymerization reactor, 92.56 kg of dry nylon salt (hexamethylene diammonium adipate salt) in 86.71 kg of water, 1380 g of caprolactam, 137 g of 32.3 wt % hexamethylene diamine in water, 9 g of manganese salt tetrahydrate, 25.9 g of pure copper acetate monohydrate, 64.7 g of potassium iodide and 6.4 g of antifoaming agent.

The polyamide was manufactured according to a standard nylon-6,6 polymerization method.

6.1 kg of a 20 wt % titanium dioxide suspension was added during the pressure distillation phase.

The polymer obtained was cast in the shape of rods, cooled and formed into granules by cutting the rods.

The viscosity index of the polymer obtained, determined from the granules, was 130 ml/g (according to the ISO EN 307 standard).

The amine end groups were measured to be 54.2 meq/kg by potentiometer.

A black pigment, a brown pigment and a yellow pigment were introduced in the form of masterbatches. A first masterbatch was made of black pigment introduced at 20% by weight into nylon-6. A second masterbatch was made of brown pigment introduced at 50% by weight into nylon-6. A third masterbatch was made of yellow pigment introduced at 25% by weight into nylon-6.

0.08 wt % of the first masterbatch, 0.048 wt % of the second masterbatch and 0.89 wt % of the third masterbatch were introduced into the PA-6,6 in an extruder at an extrusion temperature of 285° C. The blend was then melt-spun at 4200 m/min using a spinneret with 20 holes. The filaments obtained had a linear density of 1.9 dtex per strand, and a round cross section. The colour obtained was beige.

The tow was then chopped into fibres with a length of 0.9 mm.

The fibres were then subjected to an activation treatment based on tannin and aluminium sulphate. 2.2% by weight, relative to the weight of the fibres, of a product sold by Ciba under the reference CIBAFAST®) were introduced during treatment of the fibres.

### Preparation of the Flocked Surfaces

The fibres from Examples 1C, 1, 2C and 2 were then flocked on a polyamide/cotton fabric (substrate) coated with the adhesive TUBVINYL 235SL (from CHT) and 4 wt % of TUBASSIST FIX 102W (from CHT) to a thickness of 0.20/100 mm.

The fibres were flocked using a standard method. The density of the fibres on the substrate was around 70 g/m².

The flocked surface was then placed in an oven to be thermally treated in order to dry and crosslink the adhesive described above.

### Light Fastness Results

The flocked surfaces were then exposed in a Suntest XLS+ chamber comprising an air-cooled xenon arc lamp with a power of 700 W/m² between 300 and 800 nm, equipped with a window glass filter and a borosilicate filter. In the chamber, the black panel temperature was 99° C.

After an exposure of 240 and 320 hours, the change in the colour of the flocked surfaces before and after exposure was measured according to the grey scale. Grey scale:

| Exposure time | Example 1C | | Example 2C | |
|---|---|---|---|---|
| (h) | (Comparative) | Example 1 | (Comparative) | Example 2 |
| 0 | 5 | 5 | 5 | 5 |
| 240 | 3 | 4/5 | 3/4 | 4/5 |
| 320 | 2/3 | 4 | 3 | 4/5 |

The results show the obvious improvement of the product derived from coloured and stabilized fibres relative to the product derived from fibres dyed by a conventional method.

### Preparation of the Tows and Fibres

### Example 3C (Comparative)

A nylon-6,6 was manufactured according to a standard nylon-6,6 polymerization method by polymerizing nylon salt in the presence of water; caprolactam (17% by weight relative to the end polymer), manganese salt tetrahydrate (at an identical concentration to that of Example 2) and an antifoaming solution were added.

The polymer obtained was cast in the shape of rods, cooled and formed into granules by cutting the rods.

The viscosity index of the polymer obtained, determined from the granules, was 130 ml/g (according to the ISO EN 307 standard).

The amine end groups were measured to be 53 mmol/kg by potentiometer

The dried nylon-6,6 was extruded and spun at 4200 m/min using a spinneret with 20 holes and an extrusion temperature of 285° C., The filaments obtained had a linear density of 1.9 dtex per strand, and a round cross section.

The tow was then chopped into fibres with a length of 0.9 mm.

The fibres obtained were then dyed and treated.

The fibres were dyed conventionally using a method known to a person skilled in the art.

The fibres were dispersed in water. The dyeing was carried out in a bath with a dilution of 1/30 by weight.

The fibres were dyed in an open bath using the following dye: 3% of IRGALANE® RBLN Black sold by Ciba (the percentage being expressed by weight relative to the weight of the fibres). The dye chosen was a metalliferous dye recommended and used for meeting the specifications of the automotive market (UV and temperature resistance). The colour obtained was black.

Added to the dye bath were: 1% of a levelling agent, then 2.2% by weight, relative to the weight of the fibres, of a product sold by Ciba under the reference CIBAFAST® N2

The fibres were then rinsed and dried.

The fibres were then subjected to an activation treatment based on tannin and aluminium sulphate.

### Examples 3A and 3B

The polymer used was the same as that from Example 3C.

A black pigment was introduced in the form of a masterbatch in nylon-6. 4.8 wt % of the masterbatch was introduced into the PA-6,6 in an extruder at an extrusion temperature of 285° C. The blend was then melt-spun at 4200 m/min using a spinneret with 20 holes. The filaments obtained had a linear density of 1.9 dtex per strand, and a round cross section. The colour obtained was black.

The tow was then chopped into fibres with a length of 0.9 mm.

According to Example 3A, the fibres were then subjected to an activation treatment based on tannin and aluminium sulphate. 2.2% by weight, relative to the weight of fibres, of a product sold by Ciba under the reference CIBAFAST® N2 were introduced during the treatment of the fibres.

According to Example 3B, the fibres were then subjected to an activation treatment based on tannin and aluminium sulphate.

### Example 4

The nylon-6,6, the synthesis of which was described in Example 3C, was blended with a polymer D, in an amount of ⅓ nylon-6,6 from Example 3C to ⅔ polymer D by weight, during spinning.

The polymer D was a nylon-6,6 manufactured according to a standard nylon-6,6 polymerization method by polymerizing nylon salt in the presence of water; caprolactam (17% by weight relative to the end polymer), manganese salt tetrahydrate (at an identical concentration to that of Example 2), 1.5 wt % titanium dioxide and antifoaming solution were added.

A black pigment was introduced in the form of a masterbatch in nylon-6. 1.4 wt % of the masterbatch was introduced into the PA-6,6 in an extruder at an extrusion temperature of 285° C. The blend was then melt-spun at 4200 m/min using a spinneret with 20 holes. The filaments obtained had a linear density of 1.9 dtex per strand, and a round cross section. The colour obtained was grey.

### Example 5

The polymers described in Example 4 were blended in the amounts: ⅓:⅔ as before, during spinning.

A black pigment was introduced in the form of a masterbatch in nylon-6. 1.4 wt % of the masterbatch was introduced into the blend of polymers in an extruder at an extrusion temperature of 285° C.

Some Cul/Kl was also introduced in the form of a masterbatch in nylon-6. 0.51 wt % of the masterbatch was introduced into the blend of polymers in the extruder. The blend was then melt-spun at 4200 m/min using a spinneret with 20 holes.

The filaments obtained had a linear density of 1.9 dtex per strand, and a round cross section. The colour obtained was grey.

### Preparation of the Flocked Surfaces

The fibres from Examples 3C, 3A and 3B were then flocked on a polyamide/cotton fabric (substrate) coated with the adhesive TUBVINYL 235SL (from CHT) and 4 wt % of TUBASSIST FIX 102W (from CHT) to a thickness of 0.20/100 mm.

The fibres were flocked using a standard method. The density of the fibres on the substrate was around 70 g/m².

The flocked surface was then placed in an oven to be thermally treated in order to dry and crosslink the adhesive described above.

### Light Fastness Results

The flocked surfaces obtained from fibres 3C, 3A and 3B and also the tows from Examples 4 and 5, were then exposed in a Suntest XLS+ chamber comprising an air-cooled xenon arc lamp with a power of 700 W/m² between 300 and 800 nm, equipped with a window glass filter and a borosilicate filter. In the chamber, the black panel temperature was 99° C.

After an exposure of 240 and 320 hours, the change in the colour of the flocked surfaces before and after exposure was measured according to the grey scale.

Grey scale:

| Exposure time | Example 3C | | |
|---|---|---|---|
| (h) | (Comparative) | Example 3A | Example 3B |
| 0 | 5 | 5 | 5 |
| 240 | 5 | 5 | 4/5 |
| 320 | 4 | 5 | 5 |

The results show the obvious improvements for the product derived from the coloured fibres relative to the product derived from fibres dyed by a conventional method.

The true tenacity of the tows was measured before and after Suntest exposure.

Exposure time (h)

| | | | |
|---|---|---|---|
| 80 | 160 | 240 | 320 |

tenacity loss (%)

| | | | | |
|---|---|---|---|---|
| Example 4 | 41.6 | 50.0 | 50.0 | 47.0 |
| Example 5 | 13.0 | 18.4 | 21.9 | 33.3 |

The results show the good mechanical properties of tows derived from coloured fibres, in particular from coloured and stabilized fibres.

1.-17. (canceled)

18. A continuous filament thermoplastic polymer/colorant tow including a plurality of said continuous filaments and which can be converted into a variety of useful flocked articles, said continuous filaments being formed from a composition which comprised at least one matrix based on a thermoplastic polymer and a colorant and, optionally, a light and/or heat stabilizer.

19. The thermoplastic polymer/colorant tow as defined by claim 18, said colorant comprising an inorganic metal oxide.

20. The thermoplastic polymer/colorant tow as defined by claim 19, said metal oxide comprising a metal other than cadmium.

21. The thermoplastic polymer/colorant tow as defined by claim 20, said metal oxide comprising a metal other than cadmium, lead and chromium (VI).

22. The thermoplastic polymer/colorant tow as defined by claim 18, said colorant comprising an organic perylene, phthalocyanine derivative, indanthrone, benzimidazolone, quinacridone, perinone or azomethine derivative.

23. The thermoplastic polymer/colorant tow as defined by claim 22, said colorant comprising a perylene, phthalocyanine derivative or azomethine derivative.

24. The thermoplastic polymer/colorant tow as defined by claim 18, comprising at least one stabilizer selected from the group consisting of hindered phenolic antioxidants, phosphorus-based stabilizers, copper compounds and manganese compounds.

25. The thermoplastic polymer/colorant tow as defined by claim 18, said matrix comprising a polyamide.

26. The thermoplastic polymer/colorant tow as defined by claim 25, said polyamide comprising nylon-6, nylon-6,6 or blend or copolymer thereof.

27. The thermoplastic polymer/colorant tow as defined by claim 18, said continuous filaments having a linear density ranging from 0.1 to 100 dtex.

28. The thermoplastic polymer/colorant tow as defined by claim 27, said continuous filaments having a linear density ranging from 0.5 to 60 dtex.

29. A flocked article shaped from short fibers cut from continuous filaments obtained by spinning a composition comprising at least one matrix based on a thermoplastic polymer and a colorant, and, optionally, a light and/or heat stabilizer.

30. The flocked article as defined by claim 29, comprising at least 50% by weight of said short fibers.

31. The flocked article as defined by claim 29, said short fibers having a length ranging from 0.1 to 6 mm.

32. A vehicle interior lining or a vehicle interior article comprising the flocked article as defined by claim 29.

33. The vehicle interior lining/article as defined by claim 32, said vehicle being an automobile.
